(19) United States
(12) Patent Application Publication
(10) Pub. No.: US 2026/0204673 A1
(43) Pub. Date: Jul. 16, 2026

(54) MASS STREAM FLOW ARRANGEMENT IN A BATTERY RECYCLING UNIT

(71) Applicant: REGAIN SP. Z O.O., Wejherowo (PL)

(72) Inventors: Jan HUPKA, Gdansk (PL); Lukasz HUPKA, Reda (PL)

(21) Appl. No.: 19/135,602

(22) PCT Filed: Dec. 13, 2022
(86) PCT No.: PCT/PL2022/000069

§ 371 Date: Jun. 4, 2025

(30) Foreign Application Priority Data
Dec. 9, 2022 (PL) P.443100

(51) Int. Cl. H01M 10/54; B09B 3/40; B09B 3/80; B09B 101/16; H01M 6/52; H01M 10/613

(52) U.S. Cl. CPC H01M 10/54; B09B 3/40; B09B 3/80; H01M 10/613; B09B 2101/16; H01M 6/52

(57) ABSTRACT

Crushing a mass flow of cut batteries mixed with dry ice granules to obtain a mass stream of cut batteries mixed with dry ice granules and partially sublimed carbon dioxide, which is fed to an impact mill where the mixture of cut batteries and dry ice granules is crushed down to particles (size from 0.5 mm to 2.0 mm), in a gaseous carbon dioxide atmosphere, at a temperature below 40° C. The particles are passed through a sieve and the sieved particles are subjected to further separation in a CO₂ atmosphere, at a temperature below −35° C. Thereafter, the remaining anode and cathode powders are collected in a storage container, where the temperature is still maintained below −40° C. in a stream of CO₂. The excess sublimed CO₂ is directed to a hot storage, from which initially cooled batteries are transferred to a cold storage.

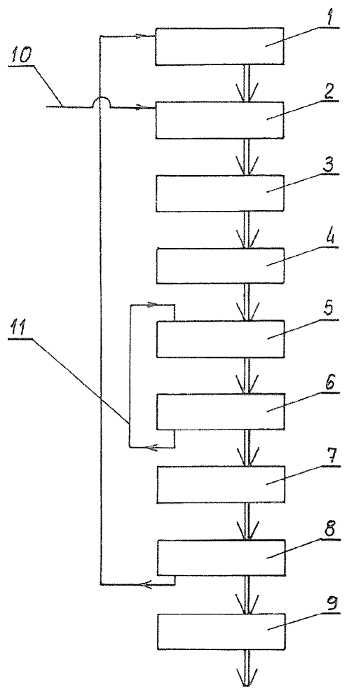

The subject of the invention is a mass stream flow arrangement in a battery recycling unit, in particular for lithium-ion cells. The invention is used in battery recycling units involving initial grinding, followed by separation of the obtained mixture into mass stream flows of solid particles and liquid materials.

Solutions in the field of battery recycling are known, in particular related to high density lithium-ion batteries. Battery grinding is the initial operation in a range of solutions. Batteries include solid materials, such as aluminium tape, copper tape, electrode powders, layers of plastic, including layers binding liquids, such as electrolytes and solvents. The known solutions are intended to separate the individual solid and liquid materials to such a degree that they can be used in production of new batteries. In known solutions, the entire recycling process may be divided into the battery fractioning stage into the powder phase and the aqueous phase. Streams of both phases include materials and raw materials, which may be used in production of new batteries. The second stage following fractioning is the stage of separation of individual material streams, which allows them to be directed to production processes for new batteries.

### SOLVENTS

Lithium-ion batteries based on a liquid electrolyte contain organic solvents, such as EC ethylene carbonate, PC propylene carbonate, DMC dimethyl carbonate, EMC ethyl-methyl carbonate and/or DEC diethyl carbonate. The EC and DMC solvents impart improved durability to the lithium-ion cells, forming a stable inter-phase layer on the graphite anode. They are also present in a mixture with other organic solvents in order to decrease the melting point from 35° C. and 3° C. to −50 ° C. and −74° C., respectively.

### ELECTROLYTES

The key properties taken into account during selection of the salt as an electrolyte component in a lithium battery include: performance at low temperatures, safety, conductivity, resistance to temperature increase, stability related to oxidation and reduction, solubility, cycle efficiency, resistance to moisture, toxicity levels and susceptibility to violent decomposition. LiPF₆ is the salt most frequently used in the electrolyte. Other salts used in lithium-ion batteries include LiFSI, LiCF₃SO₃, LiBF₄, LiClO₄, LiAsF₆, as well as more complex, organic lithium salts, such as LiTFSI, LiC₂F₆NO₄S₂, CF₃LiO₃S or LiC(SO₂CF₃)₃.

### CATHODE AND ANODE POWDERS

The cathode material (LiCoO₂, LiFePO₄, LiNiMnCoO₂, LiMn₂O₄, LiNi0.8MnCO_{0.15}Al_{0.05}O₂) is attached to aluminium foil using a conductive powder in the form of acetylene soot and poly(vinylidene fluoride) PVDF as a binder. This system is the positive electrode. The negative electrode is made of carbon powder in the form of natural graphite HC fixed on copper foil using PVDF. The anode and the cathode are separated by a polypropylene membrane, permeable to electrolyte ions. The electrolyte is a solution of lithium salts in organic solvents.

Because of the presence of electrolytes and solvents potentially causing the clumping of solid ingredients in batteries, in lithium-ion batteries, for example, the battery recycling process should be carried out at decreased temperatures. The solution according to the invention uses carbon dioxide CO₂ in the form of dry ice. Another role of this CO₂ gaseous environment is to prevent self-ignition in the device, which may occur as a result of the presence of volatile solvents. Notwithstanding the above, a significant part of technological processes should be carried out at decreased temperatures because of the aforementioned content of electrolytes and solvents, the properties of which, causing clumping of solid ingredients, are much less cumbersome at low temperatures from the point of view of separation of the product streams. The problem to be solved is thus how to maintain low temperature using carbon dioxide CO₂ accompanying most mass streams in technological battery recycling processes.

The example recycling process of lithium-ion batteries begins with their disassembly into individual cells, followed by separation. Separation of ferrous materials is another solution used in material recovery technologies. The subsequent stage is the separation of the electrolyte solution and of other raw materials, including the use of chemical processing. As liquid electrolyte, for example, solutions of lithium sulphate Li₂SO₄, lithium hexafluorophosphate LiPF₆ or lithium perchlorate LiClO₄ are used and are for example dissolved in a mixture containing various ratios of ethylene, diethyl, dimethyl and propylene.

These processes, however, must be preceded with battery fractionation into particles which may be subjected to further chemical or metallurgical processes.

A battery should be understood in this patent disclosure as the basic unit intended for energy storage, including electrodes, a separating element and electrolyte. The basic batteries are usually combined into units, however, said batteries are often marketed separately and have cylindrical, flat shape or are formed as circular discs. Such batteries are used as a power supply source for equipment and instruments, e.g. medical equipment, electrical motors in vehicles, vessels or in laptops, smartphones, power tools, remote control units and other commonly used devices. They are often offered as rechargeable batteries. Their best before date is very long and they last for years. They become waste hazardous to the environment at the end of their useful lifetime.

An example lithium-ion battery may have various shapes, it is usually cylindrical, with an approximate diameter of 18 mm and length of ca. 65 mm (the so-called 18650 cell) or diameter of 21 mm and length of 70 (the so-called 2170 cell). Such cells reach the capacity of ca. 3,000 mAh to 6,000 mAh, however, the current they are able to generate may vary and depends on their design. The most popular variant of this type of cells is the lithium-cobalt design, however, manganese or nickel at various qualitative and quantitative compositions may be used here.

A range of solutions for the execution of the recycling process for recovery of materials for re-use in the same technological process of new batteries production or in other technological processes are known. The first stage of fractionation usually is cell crushing in a crushing device. Cooled batteries are usually fed to the crushing device, wherein liquid nitrogen or carbon dioxide as dry ice are usually used in the cooling process. The cooling of batteries before the crushing increases the viscosity of the electrolyte solution present in the solvents, included in the batteries, and facilitates the subsequent separation of raw materials present therein.

An example lithium-ion cell may have various shapes, it is usually a cylindrical cell, with an approximate diameter of 18 mm and length of ca. 65 mm (the so-called 18650 cell) or diameter of 21 mm and length of 70 (the so-called 2170 cell). Such cells reach the capacity of ca. 3,000 mAh to 6,000 mAh, however, the current they are able to generate may vary and depends on their design. The most popular variant of this type of cells is the lithium-cobalt design, however, manganese or nickel at various qualitative and quantitative compositions may be used here. The disposal of used products of this type is problematic.

In a solution known from the Chinese patent document CN 108525817, a crushing device for used lithium-ion batteries operating at low temperature was disclosed at the fractionation stage. This device includes a low-temperature freezing unit, a crushing unit and an unloading unit, the low-temperature freezing unit contains a liquid nitrogen tank, a solenoid valve, a freezing container and a sealing plate. Used lithium-ion batteries are frozen in the freezing container, at low temperature. The device enables freezing of used lithium-ion batteries before crushing in order to deactivate them and crush the batteries under a cover of liquid nitrogen. Nitrogen also facilitates extinguishing of the materials if self-ignition occurs during discharging. This is followed by fractionation and separation of the obtained raw materials into streams.

According to another solution known from the Polish patent application P.4400438, the battery fractionation unit includes a battery container with temperature measurement, and a battery supplying chute and a chute supplying dry ice granules to said container. The outlet for the cooled batteries and the dry ice granules is located inside the working chamber of the cutting unit. The outlet for crushed batteries from the cutting unit is connected to the inlet to the impact mill. The outlet chute of the milled material from the impact mill is connected to a vibrating sieve chamber equipped with a pneumatic separator unit for separation of the plastic fraction present in the battery housings. The vibrating sieve chamber contains the upper sieve and the lower sieve, under which the tray for the sieved material is located. The battery container contains the hot chamber for initial battery cooling in a gaseous CO₂ atmosphere and a cold chamber for dosing dry ice granules to the initially cooled batteries. The container contains a chute dosing the mixture of dry ice and batteries to the cutting unit, where the outlet of the chute collecting the stream of crushed batteries with dry ice from the cutting unit is located inside the chamber of the impact mill. According to this solution, the high energy density battery fractionation method is characterised in that the batteries are sorted according to their physico-chemical composition, followed by transfer of the segregated battery types to the battery container, where batteries are cooled in the hot chamber of the container using gaseous CO₂. The batteries are cooled in the cold chamber using dry ice, and once the batteries reach low temperature, they are crushed, followed by pneumatic and magnetic particle separation and material sieving in the vibrating sieve chamber, and the streams of the electrolyte solution, the cathode material and the anode material are recovered.

The patent application P.442518 also discloses a solution for separation of individual raw materials from the stream of solid particles and the stream of liquids. According to this known solution, a separation method for solvents and electrolyte and of electrode powder recovery from lithium-ion cells, from the batch mixture containing solvents, electrolyte and anode and cathode powder was disclosed.

The problem to be solved according to the invention includes development of a system maintaining low temperature throughout the entire battery crushing and fractionation process, as well during the final separation of key groups of raw materials from the obtained, sieved material, intended for re-use in production of new lithium-ion batteries. Maintaining low temperature is required to ensure the ability to separate the raw materials during the battery recycling process. The first separation stage requires separation of mass streams of part elements made of plastics, ferrous metals, non-ferrous metals and mass streams of the crushed anode and cathode powders. The powders and the layers of plastics are saturated with a lithium salts electrolyte containing solvents. The objective of the solution according to the invention is to obtain the required concentration of the liquid electrolyte phase, with properties required for use in ready batteries. However, solvents and electrolytes present in the batteries cause clumping of the sieved material during crushing at ambient temperature, which makes the separation of the mass stream of the obtained mixture into mass streams of individual ingredients, such as ferrous and non-ferrous metals or anode and cathode powders, difficult. In order to avoid this phenomenon, the fractionation or battery crushing process and the subsequent separation into mass streams for individual, recovered raw materials is carried out at a decreased temperature. This prevents the clumping of particles in mass streams of the recovered raw materials.

In solutions known in the field, dry ice or liquid nitrogen are used for cooling during the process of fractionation and separation of mass streams of the recovered raw materials. Both carbon dioxide CO₂ in the form of dry ice and nitrogen have the additional advantage of being non-flammable gases, and thus counteract the spreading of fire hazard, if such hazard occurs in the described battery recycling processes. The solution according to the invention uses carbon dioxide CO₂ in the form of dry ice. Dry ice is added as granules at −78° C. to the battery mixture, before the batteries are crushed.

According to the invention, the circulating unit of mass streams in the battery recycling unit contains a cold battery storage with dry ice granules, where batteries to be crushed are stored in the first stage at a temperature below −45° C. in the cutting unit, where the mass stream of cut batteries and dry ice granules with carbon dioxide sublimed from these granules has a temperature below −45° C. The mass stream of cut batteries mixed with dry ice granules and partially sublimed carbon dioxide is fed to the impact mill, where the mixture of cut batteries and dry ice granules is finally crushed down to the particle size from 0.5 mm to 2.0 mm, in a gaseous carbon dioxide atmosphere, at a temperature below −40° C. Next, light polymers and paper are separated from the mass stream in the pneumatic separator, while the mass stream of the remaining particles is fed to the sieves, while the sieved material collected on the tray for the sieved material is subjected to further separation in a carbon dioxide CO₂ atmosphere, at a temperature below −35° C. Once the mass streams of the aforementioned materials are separated, the remaining anode and cathode powders are collected in a storage container, where the temperature is still maintained below −40° C. in a stream of carbon dioxide CO₂.

According to the invention, the mass stream flow arrangement in a battery recycling unit is characterised in that the excess of sublimed carbon dioxide CO₂ from separation of mass streams of the recycling products is directed to the hot storage, from which the initially cooled batteries are fed under gravity to the cold storage, which is supplied with dry ice granules through a chute and from which a new batch of batteries is fed with dry ice granules at a temperature below −45° C. for crushing in the cutting unit.

The sieved material obtained on the tray for the sieved material is subjected to further extraction in a separator, preferably in a carbon dioxide atmosphere, at a temperature below −30° C.

The sieved material obtained on the tray for the sieved material is obtained via low temperature fractionation on sieves, wherein the fractionation is preferably carried out in an atmosphere of gaseous carbon dioxide CO₂ in a temperature range between −78° C. and −35° C.

The electrolyte is preferably extracted during the first stage, in the separator, using dimethyl carbonate DMC as a solvent, in an amount at least twice the content of this solvent in the batteries.

During the second extraction stage in the separator, extraction using a mixture of solvent in the form of a EC+DMC+DEC mixture with volumetric ratios of 1:1:1 is preferably performed.

The solvent mixture is preferably separated from the mass stream of the electrolyte by vacuum evaporation in a rotary evaporator, wherein the evaporation is performed periodically, with the inlet and outlet lines of the gaseous carbon dioxide CO₂ to and from the evaporator are cut off.

The initially cooled mixture of batteries with added dry ice granules is fed to the cutting unit, where batteries are ground during the first stage, at a temperature below −45° C. Dry ice granules release CO₂ via sublimation, accepting heat from the batteries during the formation stage of the mass stream of cut battery fragments, after the first grinding stage in the known cutting unit. The own heat of the battery stream and the heat generated by the battery cutting unit is accepted by the subliming dry ice granules mixed with them. The mass stream of cut batteries and dry ice granules with carbon dioxide subliming from said granules, leaving the cutting unit, has a temperature between −50° C. and −45° C., which prevents the clumping of raw materials recovered during the subsequent stage.

The remaining part of the process takes place in the solution according to the invention, in a carbon dioxide CO₂ atmosphere. All components of the device and the transfer routes of mass streams during the intermediate stages of the recycling procedure, as well as during the final stages of separation into the basic ingredients, such as ferrous and non-ferrous metals, solvents, electrolyte in the form of lithium salts, plastics, paper or anode and cathode powders, are transported and subjected to separation inside the unit, under thermal insulation conditions and in tight units, preventing the loss of carbon dioxide and an increase in its temperature.

Said mass stream of cut batteries mixed with dry ice granules and carbon dioxide partially sublimed from dry ice, at a temperature below −45° C., is fed to the impact mill, where the mixture of cut batteries and dry ice granules is finally ground to the particle size between 0.5 mm and 2.0 mm, in an atmosphere of gaseous carbon dioxide, at a temperature below −40° C. As was said above, all devices and all channels of mass streams of intermediates and products of the recycling products connecting these devices are thermally insulated from the environment in order to maintain low temperature of these mass streams.

The mass stream flow arrangement in a battery recycling unit is presented as an embodiment in the attached drawing illustrating the flow of mass streams of the separated mixtures and battery components.

The flow arrangement according to the invention is presented schematically in the drawing and described below, as a description of individual operations during the battery fractioning process and during separation of the mass streams of non-ferrous metals, solvents, the electrolyte, as well as anode and cathode powders.

The mass stream flow arrangement in a battery recycling unit contains a hot storage 1 and a cold storage 2 for batteries. The mass stream 10 of dry ice granules is fed to the cold storage 2. During the first stage, the batteries and dry ice granules are crushed at −45° C. in the cutting unit 3, where the mass stream of cut batteries and dry ice granules with carbon dioxide subliming from these granules has a temperature below −55° C. The mass stream of cut batteries mixed with dry ice granules and partially sublimed carbon dioxide is fed to the impact mill 4, where the mixture of cut batteries and dry ice granules is finally crushed down to the particle size from 0.5 mm to 2.0 mm, in a gaseous carbon dioxide atmosphere, at the temperature of −40° C. Next, light polymers and paper are separated from the mass stream in the pneumatic separator 5, while the mass stream of the remaining particles is fed to the sieves 6, while the sieved material collected on the tray for the sieved material is subjected to further separation in a carbon dioxide CO₂ atmosphere, at the temperature of −42° C. Once the mass streams of the aforementioned materials are separated, the remaining anode and cathode powders are collected in a storage container, where the temperature is still maintained below −42° C. in a stream of carbon dioxide CO₂.

The excess of sublimed carbon dioxide CO₂ from separation of mass streams of the recycling products is directed to the hot storage 1, from which the initially cooled batteries are fed under gravity to the cold storage 2, which is supplied with dry ice granules 10 and from which a new batch of batteries is fed at the temperature of −55° C. for crushing in the cutting unit 3.

The sieved material obtained on the tray for the sieved material 7 is subjected to further extraction in the separator 8, preferably in a carbon dioxide atmosphere, at the temperature of −35° C. The sieved material obtained on the tray for the sieved material 7 is obtained via low temperature fractionation on sieves 6, wherein the fractionation is preferably carried out in an atmosphere of gaseous carbon dioxide CO₂ in a temperature range between −78° C. and −35° C. The electrolyte is extracted during the first stage in the separator 8, using dimethyl carbonate DMC as a solvent, in an amount at least twice the content of this solvent in the batteries. During the second extraction phase in the separator 8, the extraction is carried out using a solvent mixture in the form of an EC+DMC+DEC mixture, in volumetric ratios of 1:1:1. The solvent mixture is separated from the mass stream of the electrolyte in this embodiment by vacuum evaporation in a rotary evaporator 9, wherein the evaporation is performed periodically, with the inlet and outlet lines of the gaseous carbon dioxide CO₂ to and from the evaporator 9 are cut off.

After the final crushing in the impact mill, the stream of particles containing light polymers and paper is separated pneumatically. The mass stream of the remaining particles is fed to further separation in a carbon dioxide CO₂ atmosphere, at a temperature below −35° C. The mixture is subjected to magnetic separation of ferrous metals from non-ferrous metals, such as Al or Cu and heavy polymers, for example using sedimentation with vortex currents. Once the mass streams of the aforementioned materials are separated, the remaining anode and cathode powders are collected in a storage container, where the temperature is still maintained below −45° C. in a stream of carbon dioxide CO₂.

Excessive, sublimed carbon dioxide CO₂ is removed from the storage container to the battery storage chamber for batteries intended to be recycled, namely to the hot storage, from which the batteries are fed under gravity to the cold storage for batteries. From the cold storage, where the batteries are mixed with dry ice granules and this mixture is cooled down to −55° C., the next batch of batteries is fed for crushing into the cutting unit. The fractionation process results in a mixture on the tray for the sieved material, containing material sieved on the top sieve, and subsequently on the bottom sieve. The sieved material obtained on the tray for the sieved material 7 is subjected to further extraction in a carbon dioxide atmosphere, at the temperature of −35° C.

The mixture in the form of a mass stream of the sieved material on the tray for the sieved material 7 is obtained during low temperature crushing and fractionation on the sieves 6. The fractionation is carried out in the atmosphere of gaseous carbon dioxide CO₂ in the presented unit system, in the temperature range from −78° C. to −35° C.

The batch from the tray for the sieved material 7 is subjected to initial extraction. The batch contains mass streams of solvents, electrolytes, anode and cathode powders, obtained during low temperature separation and fractionation of the used lithium-ion batteries on sieves 6. The batch of the aforementioned mixture is separated in the amount of 10 kg in the separator, where the stream mass of the solvent is separated together with the electrolyte containing compounds of non-magnetic metals, mainly lithium.

The electrolyte solution in this embodiment contains the salt as lithium hexafluorophosphate (LiPF₆) at a concentration of 1 mol/L and a solvent mixture in the form of ethylene carbonate (EC), dimethyl carbonate (DMC) and diethyl carbonate (DEC) in the volumetric ratio of 1:1:1. The mixture of solvents and electrolytes is separated from the mass streams of the anode and cathode powders via solvent extraction in the separator 8. The separation of the electrolyte and of the solvent is carried out in the existing solvent system present in lithium-ion cells. The presence of the listed organic solvents ensures efficient exchange of ion streams between the anode and the cathode. However, because of the viscosity of the electrolyte solution in the range from 1 to 15 cP, said viscosity is decreased using the collected quantities of solvents, which increases the efficiency of electrolyte extraction from the sieved material.

During the first stage of the separation process, extraction is carried out using solvent, which is the most volatile component of the electrolyte solution in the process. Thus, heavier fractions of the mixture, including the electrolytes, are diluted and extraction is facilitated. In this embodiment, in order to create the mass stream of the mixture of the aforementioned EC+DMC+DEC solvents, dimethyl carbonate DMC is used to initiate the extraction process as the most volatile of the three solvents present in the electrolyte, in a quantity three times bigger than that in the battery. Next, following the first stage of extraction, an extraction using the obtained mixture of the solvents present in the electrolyte is carried out, in the ratios as in the electrolyte, or in this embodiment, the aforementioned EC+DMC+DEC mixture in volumetric ratios 1:1:1, and in mass ratios of the electrode material to the liquid phase of 1:3. The extraction using a solvent mixture at technological concentration in batteries in other embodiments can involve a single or multiple stages, depending on the purity requirements for the cathode and anode material.

Next, the solvent mixture is separated from the electrolyte via vacuum evaporation in a vacuum evaporator 9, under a 30 mbar vacuum. Evaporation is carried out periodically, with the inlet and outlet lines of the gaseous carbon dioxide CO₂ to the other parts of the unit cut off. Next, from the subsequent batch portions in the amount of 10 kg of the mixture fed into the reactor, the anode and cathode powder is separated through extraction, obtaining individual portions of the solvent mixture with the aforementioned quantitative composition of 1:1:1 and qualitative composition EC+DMC+DEC close to the process concentration of lithium-ion batteries, with the electrolyte containing lithium hexafluorophosphate (LiPF₆).

Next, subsequent portions of the mass stream of the solvent mixture, in this case in the amount of 1 litre per portion, are separated from the mass stream of electrolyte salts and a solvent mixture with the aforementioned quantitative composition of 1:1:1 and the qualitative composition of EC+DMC+DEC is obtained and added to the previously recovered mass streams of the solvent mixture with the same composition.

The thus obtained solvent mixture is returned to the reactor and subjected to extraction, recovering individual quantities of the aforementioned solvent mixture with electrolyte, with the same composition, separated from the anode and cathode powder.

Next, the recovered quantities of the solvent mixture, non-ferrous metal salts after electrolyte evaporation and of the cathode and anode powder which can be used in production of new lithium-ion cells are collected.

In this embodiment, the extraction of mass streams of solvents and of the electrolyte from individual batches of the mixture is carried out in the counter current, namely raffinates and solvents move in the opposite directions with lithium salts passing to the solvents between them. During the last stage, namely during the final washing stage, mass streams of heavier solvents are washed out using the mass stream of a more volatile solvent.

In this embodiment, the solvent is ethylene carbonate EC and propylene carbonate PC and dimethyl carbonate DMC and ethyl-methyl carbonate EMC and diethyl carbonate DEC mixed together in equal proportions. One of the listed solvents or a mixture of selected solvents is used in other embodiments.

In this embodiment, the aforementioned mass stream of the solvent mixture is recovered under a 30 mbar vacuum, in the rotary evaporator 9. However, before the start of evaporation, the contact between the evaporator atmosphere and the atmosphere in the remaining part of the unit filled with cold, gaseous carbon dioxide is cut off at the thermally insulated valve of the mass stream of the solvent mixture. Lithium salts in the form of a LiPF₆ solution is concentrated in this embodiment in a solvent, obtaining an electrolyte concentrate with the salt content of 4.2 mol/L. In other embodiments, the salt content varies from 3 to 6.5 mol/L.

1. Mass stream flow arrangement in a battery recycling unit, containing a hot storage, a cold storage for batteries, where batteries are stored for crushing in the first stage, at a temperature below −45° C. in a cutting unit, wherein the mass stream of cut batteries and dry ice granules and carbon dioxide subliming from said granules has a temperature below −45° C. and this mass stream of cut batteries mixed with dry ice granules and partially sublimed carbon dioxide is directed to an impact mill, where the mixture of cut batteries and dry ice granules is finally crushed to the particle size of 0.5 mm to 2.0 mm, in an atmosphere of gaseous carbon dioxide at a temperature below −40° C., followed by separation of light polymers and paper from the mass stream in a pneumatic separator, while the mass stream of the remaining particles is directed onto sieves, while sieved material from the sieves separated on the tray for the sieved material is directed to further separation in an atmosphere of gaseous carbon dioxide CO₂ at a temperature below-35° C., wherein the anode powder and the cathode powder remaining after separation of the mass streams of the aforementioned materials are collected in a storage container, where a temperature below −40° C. is still maintained in a stream of flowing carbon dioxide CO₂, wherein the excess of sublimed carbon dioxide CO₂ from the separation processes of mass streams of the recycling products is directed to the hot storage, from which initially cooled batteries are transferred to the cold storage, wherein the cold storage is supplied with dry ice granules through a chute from which, at a temperature below −45° C., another batch of batteries with dry ice granules is transferred for crushing in the cutting unit followed by the subsequent fractionation processes.

2. The flow arrangement according to claim 1, wherein the sieved material recovered on the tray for the sieved material is subjected to further extraction in the separator in a carbon dioxide atmosphere at a temperature below −30° C.

3. The flow arrangement according to claim 1, wherein the sieved material obtained on the tray for the sieved material is obtained in the process of low temperature fractionation on sieves, wherein the fractionation is carried out in a gaseous carbon dioxide CO₂ atmosphere in the temperature range from −78° C. to −35° C.

4. The flow arrangement according to claim 1, wherein the electrolyte extraction is carried out in the first stage in the separator using dimethyl carbonate DMC as a solvent, in an amount at least twice the content of this solvent in the batteries.

5. The flow arrangement according to claim 1, wherein during the second extraction stage in the separator, extraction using a mixture of solvents in the form of a EC+DMC+DEC mixture with volumetric ratios of 1:1:1 is performed.

6. The flow arrangement according to claim 1, wherein the solvent mixture is separated from the mass stream of the electrolyte by vacuum evaporation in a rotary evaporator, wherein the evaporation is performed periodically, with the inlet and outlet lines of the gaseous CO₂ to and from the evaporator are cut off.
